(19) United States
(12) Patent Application Publication
(10) Pub. No.: US 2025/0126617 A1
(43) Pub. Date: Apr. 17, 2025

(54) POTENTIAL RESOURCE AVAILABILITY INDICATION FOR MULTI-MODAL APPLICATIONS

(71) Applicant: LENOVO (SINGAPORE) Pte Limited, Singapore (SG)

(72) Inventors: Hossein BAGHERI, Urbana, IL (US); Joachim LÖHR, Wiesbaden (DE); Razvan-Andrei STOICA, Essen (DE); Vijay NANGIA, Woodridge, IL (US)

(21) Appl. No.: 18/910,937

(22) Filed: Oct. 9, 2024

Related U.S. Application Data
(60) Provisional application No. 63/589,527, filed on Oct. 11, 2023.

(51) Int. Cl. H04W 72/21; H04W 28/02; H04W 72/1268; H04W 72/232

(52) U.S. Cl. CPC H04W 72/21; H04W 28/0278; H04W 72/1268; H04W 72/232

(57) ABSTRACT

Various aspects of the present disclosure relate to receiving downlink control information (DCI) including an indication of potential uplink resource availability in a set of future uplink slots, and when uplink data for a logical channel of a logical channel group (LCG) becomes available to a medium access control (MAC) entity of a UE, performing buffer status reporting and scheduling request operations for the uplink data based on the DCI indication. The potential uplink resource availability may be used by the UE to enhance synchrony of multi-modal traffic.

### CROSS REFERENCE TO RELATED APPLICATIONS

This application claims priority to U.S. Provisional Patent Application No. 63/589,527, filed on Oct. 11, 2023, entitled POTENTIAL RESOURCE AVAILABILITY INDICATION FOR MULTI-MODAL APPLICATIONS, which is hereby incorporated by reference in its entirety.

### TECHNICAL FIELD

The present disclosure relates to wireless communications, and more specifically to handling an indication for potential uplink resource availability.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

extended Reality (XR) is an umbrella term for different types of realities including virtual reality, augmented reality and mixed reality. Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional ways to interact with the virtual reality simulation may be provided but are not strictly necessary.

Augmented reality (AR) is when a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed.

Mixed reality (MR) is an advanced form of AR where some virtual elements are inserted into the physical scene with the intent to provide the illusion that these elements are part of the real scene.

Extended reality (XR) refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

For a XR applications, haptic data, sensor data, video, and audio data need to be delivered within a small relative delay to ensure haptic-visual synchronization, which impacts a user's quality of experience. In addition, each of the data streams for XR applications (video, sensor, etc.) should be delivered within an associated latency budget. While XR applications typically synchronize multi-modal traffic flows to the extent possible, for example via time stamping, feature matching, sensor fusion, and machine learning algorithms, they fall short in ensuring synchrony in a dynamic communication network. Although XR applications can handle synchrony of multi-modal traffic themselves, the applications are not aware of network dynamics and therefore suffer from interruptions based on network activity.

### SUMMARY

The present disclosure relates to methods, apparatuses, and systems that support a potential resource availability indication (PRAI), and handling buffer status reporting (BSR) and scheduling request (SR) operations based on the indication. By considering the PRAI in BSR and SR operations, a UE can improve efficiency and synchrony of multi-modal operations.

Some implementations of the methods and apparatuses described herein may further include receiving downlink control information (DCI) including an indication of potential uplink resource availability in a set of future uplink slots, and when uplink data for a logical channel of a logical channel group (LCG) becomes available to a medium access control (MAC) entity of the UE, performing buffer status reporting and scheduling request operations for the uplink data based on the DCI indication. The DCI may have a group common format, and the DCI may have format 2_0.

In some implementations of the methods and apparatuses described herein, performing the buffer status reporting operations includes triggering a buffer status report (BSR) and constructing a corresponding BSR MAC control element (MAC-CE), and determining whether to transmit the MAC-CE in the next available slot or delay the transmission of the MAC-CE. The transmission of the MAC-CE may be delayed when the indication indicates a potential uplink resource availability in the set of future uplink slots is larger than a threshold value. The delay may have a maximum time limit, and the MAC-CE may be transmitted before or when the maximum time limit is reached. In an embodiment, the MAC-CE is transmitted when the indication indicates a potential uplink resource availability in the set of future uplink slots is larger than a threshold value, and the MAC-CE includes a field indicating how long resource allocation in response to the BSR can be delayed.

In some implementations of the methods and apparatuses described herein, the buffer status reporting and scheduling request operations include triggering a BSR, and determining whether to trigger a scheduling request when the UL-SCH resources available for a new transmission do not meet logical channel prioritization (LCP) mapping restrictions configured for the logical channel that triggered the BSR. A UE may determine to not trigger a schedule request at least temporarily (e.g., for a configured time) when the indication indicates a potential uplink resource availability in the set of future uplink slots is larger than a threshold value.

In some implementations of the methods and apparatuses described herein, a UE only performs buffer status reporting and scheduling request operations for the uplink data based on the DCI indication when the indication is received by greater than a threshold amount of time from the next uplink slot available for BSR reporting.

### BRIEF DESCRIPTION OF THE DRAWINGS

FIG. 1 illustrates an example of a wireless communications system that supports handling a potential resource availability indication in accordance with aspects of the present disclosure.

FIGS. 2 and 3 illustrate an example of a block diagram of a device that supports handling a potential resource availability indication in accordance with aspects of the present disclosure.

FIG. 4 illustrates a flowchart of a method that supports handling a potential resource availability indication in accordance with aspects of the present disclosure.

FIGS. 5A, 5B, 6A and 6B illustrate examples of sets of slots that support potential resource availability indications in accordance with aspects of the present disclosure.

### DETAILED DESCRIPTION

Many of the extended Reality (XR) and configured grant (CG) use cases are characterized by quasi-periodic traffic (with possible jitter) with high data rate in downlink (DL) (i.e., video steam) combined with the frequent uplink (UL) (e.g., pose/control update) and/or UL video stream. Both DL and UL traffic are also characterized by relatively strict packet delay budgets (PDB).

The set of anticipated XR and CG services has a certain variety and characteristics of the data streams (e.g. video) may change “on-the-fly”, while the services are running over new radio (NR). Therefore, additional information on the running services from higher layers, e.g. the QoS flow association, frame-level QoS, Application Data Unit (ADU)-based QoS, XR specific QoS etc, may be beneficial to facilitate informed choices of radio parameters. XR application awareness by UE and gNB may improve the user experience, improve the NR system capacity in supporting XR services, and reduce UE power consumption.

An ADU is the smallest unit of data that can be processed independently by an application (such as processing for handling out-of-order traffic data). A video frame can be an I-frame, P-frame, or can be composed of I-slices, and/or P-slices. I-frames/I-slices are more important and larger than P-frames/P-slices. An ADU can be one or more I-slices, P-slices, I-frame, P-frame, or a combination of those.

A service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink or multi-modal traffic with synchrony requirements) can enable more efficient (e.g., in terms of satisfying XR service requirements for a greater number of UEs, or in terms of UE power saving) XR service delivery.

If a network can provide dynamic assistance information to a UE regarding the future potential availability of UL resources or some UL resource statistics such as gNB resource utilization (how much of resources available at gNB have been allocated to users in a period of time), the UE may benefit from such assistance information on how to buffer and when to transmit different correlated streams. This disclosure offers solutions for such assistance.

In an embodiment, a gNB indicates a potential resource availability indication (PRAI) applicable to a time window to a UE. The indication may be in a physical downlink control channel (PDCCH) or a medium access control-control element (MAC-CE) message, for example. On receiving the PRAI indication, the UE determines whether to send a buffer status report (BSR) MAC-CE to the network. For example, the UE may determine whether a BSR is triggered, to delay triggering a BSR, to delay transmitting a triggered BSR, to cancel a triggered BSR, or to assign a lower priority to a BSR.

Embodiments of the present disclosure provide synchronous delivery of multi-modal traffic via resource-aware buffering at the UE. Embodiments are especially useful in time division duplex (TDD) networks with sparse UL allocation, such as networks with a ‘DDDSU’ configuration, which has only one designated UL slot in every 5 slots. Such networks may assign UL resources to the special slots (“S” slots) in addition to the designated UL slots. A PRAI indication may facilitate UE in making decisions that provide synchrony, including buffering, offloading processing to the cloud, etc.

Aspects of the present disclosure are described in the context of a wireless communications system. Aspects of the present disclosure are further illustrated and described with reference to device diagrams and flowcharts.

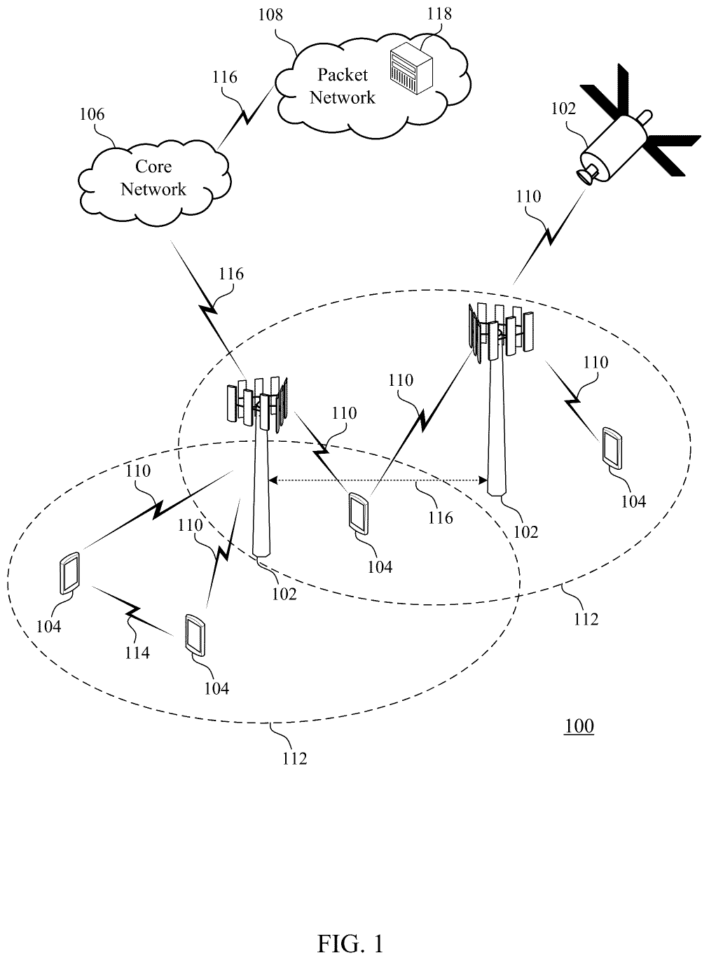

FIG. 1 illustrates an example of a wireless communications system 100 that supports handling a potential resource availability indication in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface).

In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHZ), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

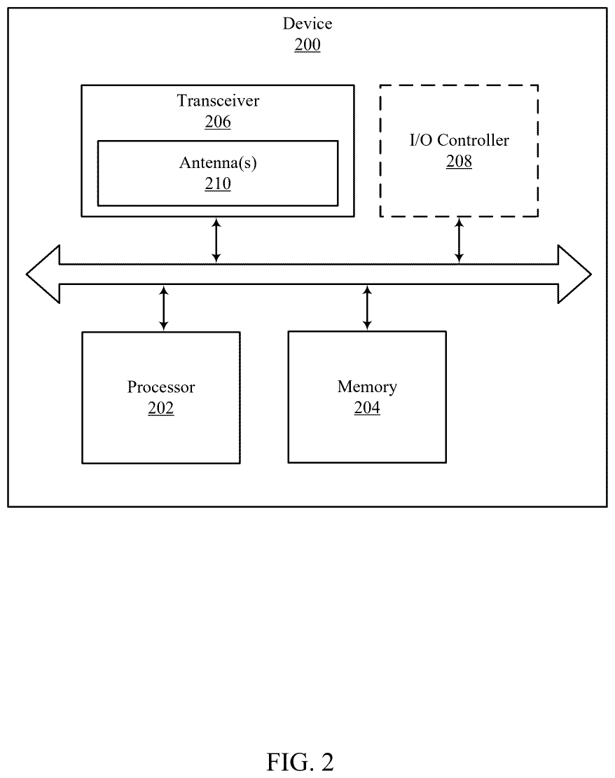

FIG. 2 illustrates an example of a block diagram 2 of a device 202 that supports handing a potential resource availability indication in accordance with aspects of the present disclosure. The device 202 may be an example of a network entity 102 or a UE 104 as described herein. The device 202 may support wireless communication with one or more network entities 102, UEs 104, or any combination thereof. The device 202 may include components for bi-directional communications including components for transmitting and receiving communications, such as a processor 204, a memory 206, a transceiver 208, and an I/O controller 210. These components may be in electronic communication or otherwise coupled (e.g., operatively, communicatively, functionally, electronically, electrically) via one or more interfaces (e.g., buses).

The processor 204, the memory 206, the transceiver 208, or various combinations thereof or various components thereof may be examples of means for performing various aspects of the present disclosure as described herein. For example, the processor 204, the memory 206, the transceiver 208, or various combinations or components thereof may support a method for performing one or more of the operations described herein.

In some implementations, the processor 204, the memory 206, the transceiver 208, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 204 and the memory 206 coupled with the processor 204 may be configured to perform one or more of the functions described herein (e.g., executing, by the processor 204, instructions stored in the memory 206).

For example, the processor 204 may support wireless communication at the device 202 in accordance with examples as disclosed herein. Processor 204 may be configured as or otherwise support a means for handing a potential resource availability indication.

The processor 204 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 204 may be configured to operate a memory array using a memory controller. In some other implementations, a memory controller may be integrated into the processor 204. The processor 204 may be configured to execute computer-readable instructions stored in a memory (e.g., the memory 206) to cause the device 202 to perform various functions of the present disclosure.

The memory 206 may include random access memory (RAM) and read-only memory (ROM). The memory 206 may store computer-readable, computer-executable code including instructions that, when executed by the processor 204 cause the device 202 to perform various functions described herein. The code may be stored in a non-transitory computer-readable medium such as system memory or another type of memory. In some implementations, the code may not be directly executable by the processor 204 but may cause a computer (e.g., when compiled and executed) to perform functions described herein. In some implementations, the memory 206 may include, among other things, a basic I/O system (BIOS) which may control basic hardware or software operation such as the interaction with peripheral components or devices.

The I/O controller 210 may manage input and output signals for the device 202. The I/O controller 210 may also manage peripherals not integrated into the device M02. In some implementations, the I/O controller 210 may represent a physical connection or port to an external peripheral. In some implementations, the I/O controller 210 may utilize an operating system such as iOS®, ANDROID®, MS-DOS®, MS-WINDOWS®, OS/2®, UNIX®, LINUX®, or another known operating system. In some implementations, the I/O controller 210 may be implemented as part of a processor, such as the processor 204. In some implementations, a user may interact with the device 202 via the I/O controller 210 or via hardware components controlled by the I/O controller 210.

In some implementations, the device 202 may include a single antenna 212. However, in some other implementations, the device 202 may have more than one antenna 212 (i.e., multiple antennas), including multiple antenna panels or antenna arrays, which may be capable of concurrently transmitting or receiving multiple wireless transmissions. The transceiver 208 may communicate bi-directionally, via the one or more antennas 212, wired, or wireless links as described herein. For example, the transceiver 208 may represent a wireless transceiver and may communicate bi-directionally with another wireless transceiver. The transceiver 208 may also include a modem to modulate the packets, to provide the modulated packets to one or more antennas 212 for transmission, and to demodulate packets received from the one or more antennas 212.

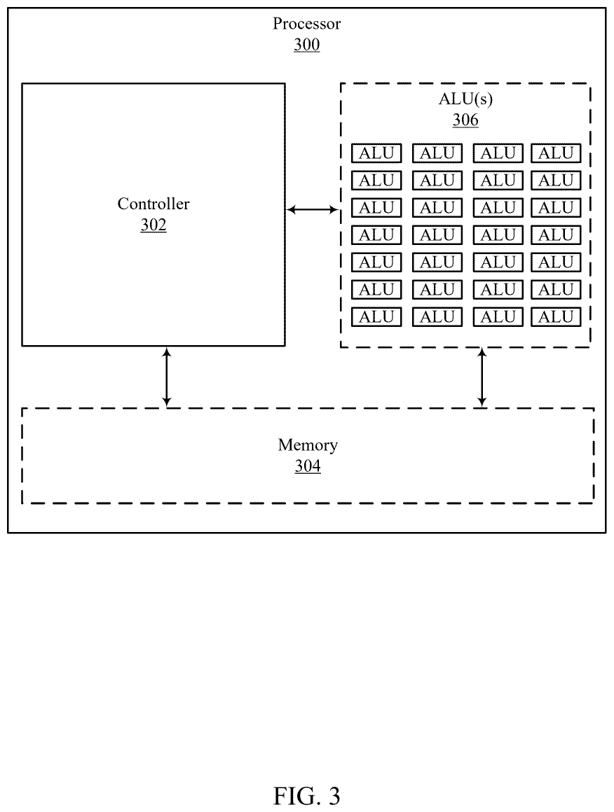

FIG. 3 illustrates an example of a processor 300 that supports handling a potential resource availability indication in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, such as L1/L2/L3 cache. Additionally, or alternatively, the processor 300 may optionally include one or more arithmetic-logic units (ALUs) 300. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory address of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein. Additionally, or alternatively, the controller 302 may be configured to manage flow of data within the processor 300. The controller 302 may be configured to control transfer of data between registers, arithmetic logic units (ALUs), and other functional units of the processor 300.

The memory 304 may include one or more caches (e.g., memory local to or included in the processor 300 or other memory, such RAM, ROM, DRAM, SDRAM, SRAM, MRAM, flash memory, etc. In some implementation, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, and the processor 300, the controller 302, and the memory 304 may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 300 may be configured to support various operations in accordance with examples as described herein. In some implementation, the one or more ALUs 300 may reside within or on a processor chipset (e.g., the processor 300). In some other implementations, the one or more ALUs 300 may reside external to the processor chipset (e.g., the processor 300). One or more ALUs 300 may perform one or more computations such as addition, subtraction, multiplication, and division on data. For example, one or more ALUs 300 may receive input operands and an operation code, which determines an operation to be executed. One or more ALUs 300 be configured with a variety of logical and arithmetic circuits, including adders, subtractors, shifters, and logic gates, to process and manipulate the data according to the operation. Additionally, or alternatively, the one or more ALUs 300 may support logical operations such as AND, OR, exclusive-OR (XOR), not-OR (NOR), and not-AND (NAND), enabling the one or more ALUs 300 to handle conditional operations, comparisons, and bitwise operations.

The processor 300 may support wireless communication in accordance with examples as disclosed herein. The processor 300 may be configured to or operable to support a means for transmitting or receiving downlink control information (DCI) including an indication of potential uplink resource availability in a set of future uplink slots.

XR-Awareness relies on QoS flows, PDU Sets, Data Bursts and traffic assistance information. Optional PDU Set QoS Parameters may be provided by the Session Management Function (SMF) to the gNB as part of the QoS profile of the QoS flow. These QoS parameters include a PDU Set Delay Budget (PSDB), which is an upper bound for the duration between the reception time of the first PDU (at the UPF for DL, at the UE for UL) and the time when all PDUs of a PDU Set have been successfully received (at the UE in DL, at the UPF in UL). A QOS Flow is associated with only one PSDB, and when available, it applies to both DL and UL and supersedes the PDB of the QoS flow. Another QoS parameter is PDU Set Error Rate (PSER), which is and upper bound for a rate of non-congestion related PDU Set losses between RAN and the UE. A QoS Flow is associated with only one PSER, and when available, it applies to both DL and UL and supersedes the PER of the QoS flow. A PDU set may be considered as successfully delivered only when all PDUs of a PDU Set are delivered successfully. Another QoS parameter is PDU Set Integrated Handling Information (PSIHI), which indicates whether all PDUs of the PDU Set are needed for the usage of PDU Set by application layer. The PDU Set QoS parameters may be common for all PDU Sets within a QoS flow.

In addition, the UPF can identify PDUs that belong to PDU Sets, and may determine the following PDU Set Information which it sends to the gNB in the GTP-U header: PDU Set Sequence Number; Indication of End PDU of the PDU Set; PDU Sequence Number within a PDU Set; PDU Set Size in bytes; and PDU Set Importance (PSI), which identifies the relative importance of a PDU Set compared to other PDU Sets within the same QoS Flow. Traffic assistance information may also be provided by 5GC to the gNB, including, via Time Sensitive Communication Assistance Information (TSCAI): UL and/or DL Periodicity, and N6 Jitter Information (i.e. between UPF and Data Network) associated with the DL Periodicity, and an indication of end of data burst in the GTP-U header of the last PDU in downlink. In the uplink, the UE needs to be able to identify PDU Sets and Data Bursts dynamically, including PSI. How this is done is left up to UE implementation.

In order to enhance the scheduling of uplink resources for XR, improvements have been introduced to 3GPP standards. One improvement is an additional BS table to reduce the quantisation errors in BSR reporting (e.g. for high bit rates). The code points of this table follow a linear distribution. The gNB configures the BS table(s) that an LCG is eligible to use, and when there is more than one, the UE selects the table. In another improvement, delay knowledge of buffered data, consisting of remaining time, and distinguishing how much data is buffered for which delay is available. This data may be reported with BSR in a single MAC CE or in a separate MAC CE. Additional improvements are additional BSR triggering conditions to allow timely availability of buffer status information which can be investigated further, and reporting of uplink assistance information (jitter range and burst arrival time) per QoS flow by the UE via UE Assistance Information.

When the PDU Set Integrated Handling Indication (PSIHI) is set for a QoS flow, as soon as one PDU of a PDU set is known to be lost, the remaining PDUs of that PDU Set can be considered as no longer needed by the application and may be subject to discard operations at the transmitter to free up radio resources. However, it cannot always be assumed that the remaining PDUs are not useful and can safely be discarded. Also, in case of Forward Error Correction (FEC), active discarding of PDUs when assuming that a large enough number of packets have already been transmitted for FEC to recover without the remaining PDUs is not recommended as it might trigger an increase of FEC packets.

In uplink, a UE may be configured with a PDU Set based discard operation for a specific data radio bearer (DRB). When configured, the UE discards all packets in a PDU set when one PDU belonging to this PDU set is discarded, e.g. based on discard timer expiry. In case of congestion, the PDU session identity (PSI) may be used for PDU set discarding. In uplink, dedicated signaling may be used to trigger discard mechanism based on PSI. For configured grant (CG) transmissions, multiple CG Physical Uplink Shared Channel (PUSCH) transmission occasions may be in a period of a single CG PUSCH configuration, and the transmission may include a dynamic indication of unused CG PUSCH occasion(s) based on UCI (e.g. CG-UCI or a new UCI) by the UE.

DCI format 2_0 may include an availableRB-SetsPerCell indication. If a UE is provided availableRB-SetsPerCell, the UE is not required to monitor PDCCH candidates that overlap with any Resource Block (RB) from RB sets that are indicated as unavailable for receptions by an available RB set indicator field in DCI format 2_0 as described in clause 11.1.1 of TS 38.213. If the UE does not obtain the available RB set indicator for a symbol, the UE monitors PDCCH candidates on all RB sets in the symbol.

availableRB-SetsPerCell is an available RB set indicator field in DCI format 2_0 that is one bit, if intraCellGuardBandsDL-List for the serving cell indicates no intra-cell guard-bands are configured, where a value of ‘1’ indicates that the serving cell is available for receptions, a value of ‘0’ indicates that the serving cell is not available for receptions, by availableRB-SetsPerCell, and the serving cell remains available or unavailable for reception until the end of the remaining channel occupancy duration, or a bitmap having a one-to-one mapping with the RB sets of the serving cell, if intraCellGuardBandsDL-List for the serving cell indicates intra-cell guard-bands are configured, where the bitmap includes NRB,set,DL bits and NRB, set,DL is the number of RB sets in the serving cell, a value of ‘1’ indicates that an RB set is available for receptions, a value of ‘0’ indicates that an RB set is not available for receptions, by availableRB-SetsPerCell and a RB set remains available or unavailable for receptions until the end of the remaining channel occupancy duration.

In some embodiments of this disclosure, the available RB set indicator field in DCI format 2_0 is re-purposed. The original purpose of this field is to indicate to the UE which RB sets/serving cells are available for reception during the indicated remaining channel occupancy duration. However, embodiments of this disclosure may re-purpose the field to indicate which RB sets can be potentially available in future slots for uplink transmission as opposed to downlink reception. In addition, certain related UE actions and behaviors may be modified as discussed below.

In an embodiment of the present disclosure, a gNB indicates a potential resource availability indication (PRAI) applicable to a time window to UEs. The PRAI indication may be provided to UEs in a PDCCH or a MAC-CE message. In particular the PRAI indication may be provided in DCI. A UE may determine whether and how to trigger and transmit a BSR MAC-CE to the network.

Such a technique could be especially useful in TDD networks with sparse UL allocation such as a ‘DDDSU’ configuration, having 1 UL slot in every 5 slots. PRAI can help UEs in making decisions related to buffering, offloading processing to cloud, etc.

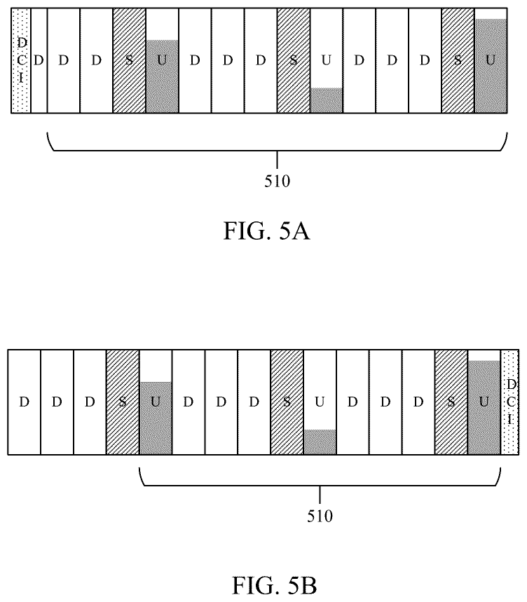

In some embodiments, the duration of the time window encompassed by the PRAI can be configured and can include UL only or UL and DL slots. For example, PRAI can be configured to encompass a specific number of UL slots, or a number of slots regardless of whether the slots are designated to UL or DL. For example, in FIG. 5A, the PRAI encompasses the set 510 of 14 slots in which both DL and UL slots are considered, and in FIG. 5B, the PRAI encompasses the set 510 of three UL slots when only UL slots are considered.

In an embodiment, a gNB can determine potential resource availability based on gNB implementation. For example, the gNB can use load prediction e.g., via machine learning algorithms, to construct the PRAI. In addition or as an alternative, the gNB may consider CG resources configured for active UEs, scheduling grants already sent to UEs, etc. In some embodiments, instead of a time window, PRAI can be applicable to the next ‘M’ slots. The PRAI is an indication that provides information to a UE about the possibility of resource availability in the future, and not a guarantee of allocated resources.

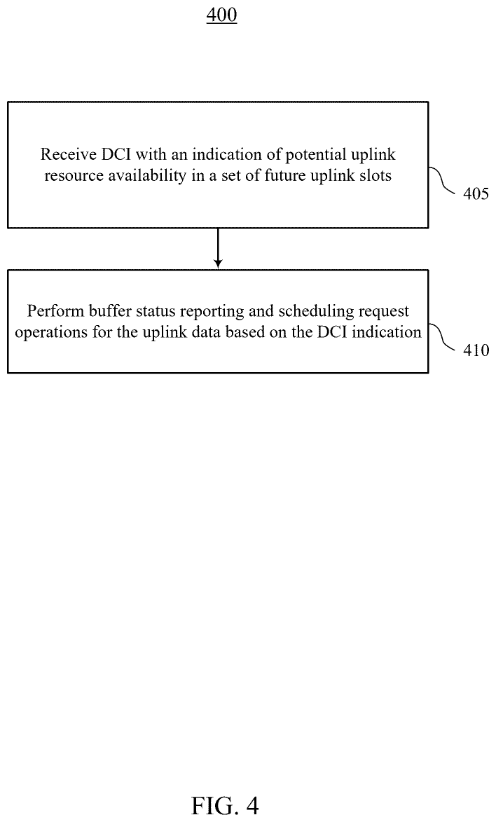

FIG. 4 illustrates a flowchart of a method 400 that supports handling a potential resource availability indication in accordance with aspects of the present disclosure. The operations of the method 400 may be implemented by a device or its components as described herein. For example, the operations of the method 400 may be performed by a UE 104 as described with reference to FIGS. 1 through 2. In some implementations, the device may execute a set of instructions to control the function elements of the device to perform the described functions. Additionally, or alternatively, the UE 104 may perform aspects of the described functions using special-purpose hardware.

At 405, the method may include receiving DCI with an indication of potential uplink resource availability, e.g. a PRAI indication, in a set of future uplink slots. The operations of 405 may be performed in accordance with examples as described herein. In some implementations, aspects of the operations of 405 may be performed by a device as described with reference to FIG. 1.

A PRAI may be transmitted by a gNB in a group-common DCI. The DCI may comprise a predetermined number of fields for a PRAI indication. In some embodiments, one or more fields in the PRAI indicate a sequence of UL resource availability indications. The resource availability indications may be in a unit of time-frequency resources such as number of resource block groups (RBGs) or fraction of the RBGs within a bandwidth part (BWP) corresponding to a set of slots 510 after a reference time. The time-frequency unit size may be configured, for example, as a slot and multiples of RBGs, or in the case of multi-TRPs (M-TRP), in half of a slot and multiples of RBGs.

The reference time may be the slot in which the indication is sent, especially for lower subcarrier spacing (e.g., less than 60 KHz), and may be a future slot for higher subcarrier spacing (such as 480 KHz) to provide sufficient processing time for the UE. The reference time may be selected to provide the UE with enough time to decode the DCI and determine whether and how to construct and multiplex a BSR/DSR into a PUSCH transmission, as will be described in more detail below.

The number of slots encompassed by the PRAI may be configured via RRC signaling. In an embodiment, the number of slots is determined based on the periodicity of the search space associated with the DCI. For example, the set of slots 510 encompassed by the PRAI may cover slots within one period of the search space.

In an embodiment, an MCS sub-field associated with potential data transmission in each of the slots in set 510 can also be included in the field. Such an MCS sub-field may help the UE determine how much of its data can be conveyed by the potentially available resources.

FIGS. 5A and 5B illustrate examples of slots that support handling a potential resource availability indication in accordance with aspects of the present disclosure. In particular, FIGS. 5A and 5B illustrate slots with a DDDSU format in a TDD system. Downlink slots are designated by the letter D, uplink slots are designated by the letter U, and special slots are designated by the letter S. Special slots S generally contain 14 symbols, can be designated as uplink or downlink, can contain DL and UL symbols and have a guard interval between the DL and UL symbols.

In the example of FIG. 5A, the PRAI indication applies to the set of 14 slots 510. In other embodiments, the set of slots 510 may be a different number, e.g. 11, which spans all three uplink slots U shown in FIG. 5, or 12, which spans the three uplink slots U as well as the special slot S before the first uplink slot U. The number of slots in a set 510 for a PRAI may also vary depending on the slot format.

The indication applies to potential resource availability in uplink slots U, and may also be applicable to the special slots S in some embodiments. That is, in some embodiments, PRAI takes potential resource availability of special slots S into account in addition to resource availability of uplink slots U. In the examples of FIGS. 5A and 5B, the non-shaded areas in the uplink slots U indicate different potential availability in uplink slots, where there is limited or about ⅓ potential availability in the first uplink slot, high availability in the second uplink slot, and very limited availability in the final uplink slot. This information can be conveyed to UEs in PRAI in several different ways, including as specific resources as explained above, or as resource utilization.

In some embodiments, one or more fields in the PRAI indicate an uplink resource utilization that is calculated within a resource utilization time window (RUTW) that corresponds to the set of slots 510 encompassed by the PRAI. In this case, the PRAI may indicate the resource utilization per slot within the RUTW or for all slots within the RUTW. In an embodiment, the PRAI may individually indicate resource utilization for each uplink slot within the RUTW, or for each uplink slot and each special slot. In another embodiment, the PRAI may indicate a single utilization value for the entire RUTW.

The duration of the RUTW may be configured by RRC or designated based on the periodicity of the DCI, for example. In one embodiment, the duration of the RUTW is set based on a configured number of future uplink slots, e.g. the duration may be an amount of time or number of slots that includes a specific number of uplink slots. In other embodiments, the RUTW duration is based on the periodicity or average periodicity of traffic for the application associated with uplink traffic from the UE, e.g., an average FPS of a video stream, 20 ms for audio and 10 ms for haptics streams, etc. The RUTW duration can include both downlink & uplink slots or only uplink slots.

The RUTW may end at the last slot before transmission of a DCI. An example of this is shown in FIG. 5B, in which the set of slots 510 for the PRAI duration spans three uplink slots and terminates before the DCI transmission. In this example, resource usage is calculated based on past resource utilization. In an embodiment in which resource utilization is based on future transmissions, for example as illustrated in FIG. 5A, the RUTW may start at the first slot after DCI, or some number of slots after DCI. In an embodiment, the start and/or end of an RUTW can be indicated by the DCI.

The indicated resource utilization may only be applicable to the current BWP of the UE. If a UE changes the BWP, any resource utilization values for the previous BWP are not longer valid and the UE may wait for new resource utilization values for the new BWP before taking action with respect to the PRAI.

The resource utilization may be indicated based on a percentage of resources utilized for the applicable slots. For example, the PRAI may be a two-bit indication in which each respective combination of bits represents a value of below 25% resource utilization, a value of 25 to 50% utilization, a value of 50-75% utilization, and a value of above 75% utilization. However, these values are only examples. In an embodiment, the specific values are configurable by the network.

A PRAI may include indications for multiple UEs. In an embodiment, UEs are configured with a field position index identifying which of the PRAI fields is applicable to the UE. In the case of carrier aggregation, each carrier may be associated with a PRAI field. In various embodiments, fields of the PRAI can be per UE, per carrier, or per LCG. For example, a UE can be configured with multiple field position indices identifying which of the PRAI fields are applicable to which carrier and/or which LCG.

A UE may trigger an event leading the network to transmit PRAI fields in DCI. For example, a UE may send a MAC-CE and indicate for how long, and possibly with what frequency, the UE is to receive such assistance information, and the type of assistance information to be received (e.g., a single RU value or a bitmap). The MAC-CE may be used to activate or de-activate the PRAI receptions. In an embodiment, the UE may report (e.g., via UE capability reporting) to the network when the UE is capable of processing PRAI and operating BSR and SR procedures based on PRAI, and in response to indicating the capability of using this feature, the network may configure the UE with an RRC parameter such as “gNB-assistance-Resource-Availability”, which enables the UE to receive PRAI indications.

The available RB set indicator field in DCI format 2_0 can be re-purposed for such reporting. If the UE is configured with an RRC parameter (e.g., “gNB-assistance-Resource-Availability”), the UE may ignore another RRC parameter (such as intraCellGuardBandsDL-List) specified in 3GPP for interpreting the available RB set indicator field in DCI format 2_0. In such an embodiment, a value of ‘1’ in the available RB set field may indicate that an RB set is potentially available for transmissions (still subject to receiving a grant allocating/confirming/modifying such resources), and a value of ‘0’ may indicate that an RB set is not available for transmissions (still subject to not receiving an UL grant stating otherwise), by availableRB-SetsPerCell, and a RB set remains available or unavailable for transmissions until the next time window. In another embodiment, the DCI indicates whether the available RB set indicator field in DCI format 2_0 is for an existing or specified purpose (indicating availability for reception) or for a new purpose (e.g. PRAI indication). For instance, a field in DCI format 2_0 may indicate whether the available RB set indicator field corresponds to reception availability or transmission availability (PRAI). The configured or determined RB sets can be different for different purposes, e.g. reception and transmission purposes.

The remaining channel occupancy, which may also be indicated within DCI format 2_0, may be repurposed if “gNB-assistance-Resource-Availability” is configured to indicate the time window. A gNB may send a scheduling DCI with a new DCI format, wherein the DCI confirms or denies potentially available resources previously indicated by PRAI at least for one UL slot (e.g., the first UL slot after the scheduling DCI). gNB-assistance-Resource-Availability may be applicable to licensed bands, and/or unlicensed or shared spectrum.

If the UE has not received a PDCCH scheduling uplink resources within ‘T’ time units after receiving the DCI indicating potential available resources (referred to as DCI1), the UE may assume the DCI1 indication is no longer valid. Otherwise, the UE may assume the indication is valid until receiving another DCI indicating potential available uplink resources. This could be useful for BSR handling.

The gNB may indicate in the PRAI that the information is not available (e.g., if the UE has recently switched BWP). Alternatively, if the UE has recently switched (UL) BWP, the UE may not be expected to monitor DCI format indicating PRAI for at least a predetermined number of time units or PDCCH monitoring occasions.

At 410, the method may include performing buffer status reporting and scheduling request operations for the uplink data based on the DCI indication. The operations of 410 may be performed in accordance with examples as described herein. In some implementations, aspects of the operations of 410 may be performed by a UE 104 as described with reference to FIG. 1.

When uplink data for a logical channel of a LCG becomes available to a MAC entity of the UE, the UE may perform buffer status reporting and scheduling request operations for the uplink data based on the PRAI. The UE can use the information in the PRAI to determine which actions to take to optimize synchrony. One advantage of embodiments of the present disclosure is that if the UE is aware that sufficient resources are potentially available, as indicated by a positive PRAI, the UE can buffer data. On the other hand, if PRAI indicates limited potential resources, the UE may request resources immediately to ensure synchronization.

In an embodiment, when a UE receives PRAI indicating resource availability larger than a configured or specified threshold or a Resource Utilization (RU) value less than a configured or specified threshold, the UE may take one of the following actions: triggering a BSR, delaying the trigger of a BSR, delaying the transmission of a triggered BSR, cancelling a BSR, assigning a lower priority to a triggered BSR, or changing the priority of a BSR and/or its associated LCG.

In an example, the UE is not required to trigger a BSR in response to arrival of new data when an RRC parameter the “gNB-assistance-Resource-Availability” parameter is set, and the UE receives a PRAI indication indicating potential resource availability larger than a threshold or RU less than a threshold. If the UE delays triggering a BSR, the delay may be by a configured or predetermined amount of time, or until the UE receives another DCI, which could be a scheduling DCI or a DCI with PRAI. A triggered BSR may be delayed or cancelled until more data is buffered by the UE when PRAI indicates a high probability of sufficiently large (e.g., larger than a threshold) resource availability.

When the UE assigns a lower priority to a triggered BSR, the priority can be used for choosing between triggered BSRs, transmission of BSR in an UL channel, etc. An example of the UE changing the priority of a BSR and/or its associated LCG is when partial video content is in a LCH with lower priority and audio content is in a separate LCH, but the video PDB is about to expire while that of audio is not. In this case, the video data priority may be upgraded based on the PRAI to be sent within the current or future slot, thus preempting the audio. Persons of skill in the art will recognize that the various actions of the UE described above can be implemented in many different scenarios to provide synchronization between multiple data streams.

In an embodiment, the UE transmits a triggered BSR and indicates that this BSR should be deferred. This indication may be provided in a new field in the BSR MAC-CE, and the BSR may be deferred until further BSR notification, until a predetermined time, or by an indicated value in the BSR MAC-CE. In an embodiment, the BSR is deferred by at most a predetermined time, so that if an event has not occurred by a predetermined time the BSR is processed by the network. One benefit of notifying a gNB about a deferred BSR is to let the gNB know that the UE has some data to transmit, but the UE is waiting a bit more to get other correlated traffic and will send another BSR asking for resources for transmission when that traffic is available.

A deferred BSR may also indicate a remaining delay budget associated to at least one LCG, and the delay status reporting (DSR) framework can be used for such an indication. A DSR may be triggered if a BSR is going to be triggered or already triggered, and the gNB can delay allocating resources in response to the BSR reception by the indicated delay in the DSR. A field in the DSR can distinguish this type of DSR, which is a new DSR type, from the DSR indicating the remaining delay budget for a data, which is a conventional DSR. In an embodiment, a gNB may quickly allocate resources for UL transmissions in response to the regular DSR, while the gNB may delay resource allocation in response to this new DSR type.

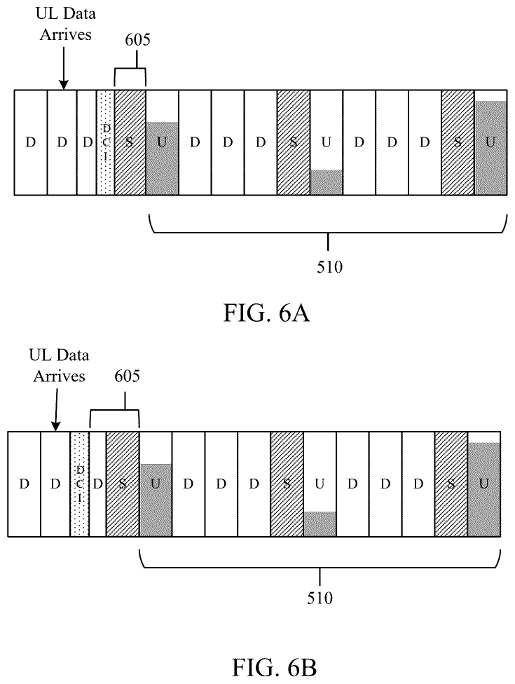

In some embodiments, the PRAI may need to be received at least a certain time (determined by a PUSCH preparation time) in advance of a PUSCH occasion carrying the BSR or DSR (e.g., the PUSCH occasion wherein the UE would have transmitted the BSR or DSR if no associated PRAI was received). An example of this behavior will be explained with respect to FIGS. 6A and 6B.

In FIGS. 6A and 6B, uplink data arrives at a UE's buffer during a downlink slot at the same time in both figures. The arrival of data at the UE's buffer triggers a BSR per legacy operations. The UE later receives a PRAI indicating potential resource availability larger than a threshold in a set of slots 510 in the DCI shown in the figures.

The primary difference between FIG. 6A and FIG. 6B is the size of the gap 605 between the DCI with the PRAI and the first uplink slot in the subsequent set of slots 510 associated with the PRAI. If the gap 605 is too small as in FIG. 6A, the UE may simply perform legacy BSR operations and transmit the BSR in the first uplink slot if the UE was previously scheduled to transmit in that slot since the gap 605 between the PRAI and the first UL slot is shorter than a threshold gap. On the other hand, if the gap 605 is larger than a threshold value as shown in FIG. 6B, the UE takes the PRAI into account and cancels the triggered BSR, delays the transmission of the BSR, or indicates in the BSR that the resource allocation in response to the BSR can be delayed, for example. The threshold value for the gap 605 may be determined based on a PUSCH preparation time defined in TS 38.214.

In an embodiment, a deferred BSR can be overridden by a later BSR. Examples of overriding a BSR are canceling, expiring or updating the BSR. The BSR may be overridden when data of another correlated stream (e.g., in a multi-modal communication wherein multiple streams need to be communicated within certain relative latency) arrives.

When the UE delays or defers a BSR, the delay or deferment can be continued up to a maximum time or number of slots, for example 4 slots, after which the UE may transmit the BSR. The maximum time can be configurable, set as a predetermined value, or determined by the UE. For example, the UE may determine the maximum time based on the delay budget of the LCG for which the BSR was triggered. In some embodiments, the UE may delay or defer the BSR triggering or transmission when the new uplink data is only related to certain logical channels, for example LCGs associated to a multi-modal communication such as those associated with a multi-modal ID.

The UE may consider a positive PRAI as a grant for the purpose of BSR handling conditioned on meeting QoS (such as latency) requirements of the associated service. Here, a positive PRAI is when potential resource availability is larger than a threshold or RU is smaller than a threshold. For example, if a BSR is triggered and the UL-shared channel resources available for a new transmission do not meet the LCP mapping restrictions (e.g. as explained in clause 5.4.3.1 of TS 38.321) configured for the logical channel that triggered the BSR, the UE triggers a scheduling request (SR) if it hasn't received a positive PRAI or the UE triggers a scheduling request but delays transmission of the SR if it has received a positive PRAI.

A UE may skip triggering a BSR if it has received a PRAI within a first amount of time prior to the BSR triggering event. The UE may cancel a triggered BSR or delay transmission of the BSR if a PRAI is received after a BSR has been triggered BSR (e.g., not later than a second amount time after the event triggering the BSR). The UE may send a BSR MAC-CE indicating to the network that the gNB is to defer allocating resources in response to the BSR MAC-CE if the PRAI received more than the second amount of time and less than a third amount of time. Accordingly, in some embodiments, the UE may perform different actions depending on when PRAI is received.

It should be noted that the methods described herein describes possible implementations, and that the operations and the steps may be rearranged or otherwise modified and that other implementations are possible. Further, aspects from two or more of the methods may be combined. For instance, the embodiments regarding BSR handling based on PRAI can be applicable to DSR handling with slight modifications.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive downlink control information (DCI) including an indication of potential uplink resource availability in a set of future uplink slots; and
when uplink data for a logical channel of a logical channel group (LCG) becomes available to a medium access control (MAC) entity of the UE, perform buffer status reporting and scheduling request operations for the uplink data based on the DCI indication.

2. The UE of claim 1, wherein the at least one processor is further configured to cause the UE to, when performing the buffer status reporting operations:
trigger a buffer status report (BSR) and constructing a corresponding BSR MAC control element (MAC-CE); and
determine whether to transmit the MAC-CE in the next available slot or delay the transmission of the MAC-CE.

3. The UE of claim 2, wherein the at least one processor is further configured to cause the UE to delay the transmission of the MAC-CE when the indication indicates a potential uplink resource availability in the set of future uplink slots is larger than a threshold value.

4. The UE of claim 3, wherein the delay of the transmission of the MAC-CE has a maximum time limit, and the at least one processor is further configured to cause the UE to transmit the MAC-CE before or when the maximum time limit is reached.

5. The UE of claim 2, wherein the at least one processor is further configured to cause the UE to transmit the MAC-CE when the indication indicates a potential uplink resource availability in the set of future uplink slots is larger than a threshold value, and the MAC-CE includes a field indicating how long resource allocation in response to the BSR can be delayed.

6. The UE of claim 1, wherein the buffer status reporting and scheduling request operations include:
triggering a BSR; and
determining whether to trigger a scheduling request when Uplink Shared Channel (UL-SCH) resources available for a new transmission do not meet logical channel prioritization (LCP) mapping restrictions configured for a logical channel that triggered the BSR.

7. The UE of claim 6, wherein the at least one processor is further configured to cause the UE to determine not to trigger a schedule request when the DCI indication indicates that a potential uplink resource availability in the set of future uplink slots is larger than a threshold value.

8. The UE of claim 1, wherein the DCI has a group common format.

9. The UE of claim 1, wherein the at least one processor is further configured to cause the UE to only perform buffer status reporting and scheduling request operations for the uplink data based on the DCI indication when the DCI indication is received by greater than a threshold amount of time from the next uplink slot available for BSR reporting.

10. The UE of claim 1, wherein the DCI has format 2_0.

11. A processor for wireless communication, comprising:
at least one memory; and
at least one controller coupled with the at least one memory and configured to cause the processor to:
receive downlink control information (DCI) including an indication of potential uplink resource availability in a set of future uplink slots; and
when uplink data for a logical channel of a logical channel group (LCG) becomes available to a medium access control (MAC) entity of the UE, perform buffer status reporting and scheduling request operations for the uplink data based on the DCI indication.

12. The processor of claim 11, wherein the at least one controller is further configured to cause the processor to, when performing the buffer status reporting operations:
trigger a buffer status report (BSR) and constructing a corresponding BSR MAC control element (MAC-CE); and
determine whether to transmit the MAC-CE in the next available slot or delay the transmission of the MAC-CE.

13. The processor of claim 12, wherein the at least one controller is further configured to cause the processor to delay the transmission of the MAC-CE when the indication indicates a potential uplink resource availability in the set of future uplink slots is larger than a threshold value.

14. The processor of claim 13, wherein the delay of the transmission of the MAC-CE has a maximum time limit, and the at least one controller is further configured to cause the processor to the MAC-CE before or when the maximum time limit is reached.

15. The processor of claim 12, wherein the at least one controller is further configured to cause the processor to transmit the MAC-CE when the indication indicates a potential uplink resource availability in the set of future uplink slots is larger than a threshold value, and the MAC-CE includes a field indicating how long resource allocation in response to the BSR can be delayed.

16. The processor of claim 11, wherein the buffer status reporting and scheduling request operations include:
triggering a BSR; and
determining whether to trigger a scheduling request when Uplink Shared Channel (UL-SCH) resources available for a new transmission do not meet logical channel prioritization (LCP) mapping restrictions configured for a logical channel that triggered the BSR.

17. The processor of claim 16, wherein the at least one controller is further configured to cause the processor to determine not to trigger a schedule request when the DCI indication indicates that a potential uplink resource availability in the set of future uplink slots is larger than a threshold value.

18. The processor of claim 11, wherein the DCI has a group common format.

19. The processor of claim 11, wherein the at least one controller is further configured to cause the processor to only perform buffer status reporting and scheduling request operations for the uplink data based on the DCI indication when the DCI indication is received by greater than a threshold amount of time from the next uplink slot available for BSR reporting.

20. A method performed by a user equipment (UE), the method comprising:
receiving downlink control information (DCI) including an indication of potential uplink resource availability in a set of future uplink slots; and
when uplink data for a logical channel of a logical channel group (LCG) becomes available to a medium access control (MAC) entity of the UE, performing buffer status reporting and scheduling request operations for the uplink data based on the DCI indication.
